(19) United States
(12) Patent Application Publication
(10) Pub. No.: US 2025/0200947 A1
(43) Pub. Date: Jun. 19, 2025

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: FUMINORI HOMMA, TOKYO (JP)

(21) Appl. No.: 18/849,482

(22) PCT Filed: Feb. 28, 2023
(86) PCT No.: PCT/JP2023/007234

§ 371 Date: Sep. 21, 2024

(30) Foreign Application Priority Data
Mar. 30, 2022 (JP) 2022-057622

(51) Int. Cl. G06V 10/774; G06T 13/40; G06V 40/10; G06V 40/20

(52) U.S. Cl. CPC G06V 10/774; G06T 13/40; G06V 40/103; G06V 40/20

(57) ABSTRACT

An information processing apparatus according to an embodiment includes: an abstraction processing unit (101) that performs abstraction, from a plurality of directions, on a human body model having three-dimensional information and indicating a first pose associated with a first label, generates a plurality of pieces of first abstracted information each having two-dimensional information and corresponding to the plurality of directions by performing the abstraction, and associates the first label with each of the plurality of pieces of first abstracted information. The plurality of pieces of first abstracted information and second abstracted information having two-dimensional information obtained by abstracting a second pose corresponding to the first pose in one domain are used for associating the first label with the second pose in the one domain.

### FIELD

The present disclosure relates to an information processing apparatus, an information processing method, and an information processing program.

### BACKGROUND

Non-verbal communication, which is communication based on information other than language, is known to have an important meaning in communication between people. In the non-verbal communication, communication between people is performed according to information such as an expression, a voice tone, and a gesture.

There is a case where it is desired to detect a non-verbal action of a counterpart in remote communication for performing communication between users by transmitting and receiving video and audio via the Internet. For example, in the remote communication, there is a case where a document image and a voice of a user are transmitted to the counterpart, and a video obtained by capturing the user with a camera in real time is not transmitted. In this case, since a communication counterpart cannot see a gesture or expression of a transmitting user, there is a possibility that the feeling or the like of the transmitting user cannot be read.

### CITATION LIST

### Non Patent Literature

Non Patent Literature 1: G″ul Varol, three others “Synethetic humans for Action Recognition from Unseen Viewpoints”, [online], May 23, 2021, International Journal of Computer Vision, [Searched on Mar. 12, 2022], Internet <https://arxiv.org/pdf/1912.04070.pdf>
Non Patent Literature 2: Christoph Feichtenhofer, three others “SlowFast Networks for Video Recognition”, [online], Oct. 23, 2019, Facebook AI Research (FAIR), [Searched on Mar. 18, 2022], Internet <https://arxiv.org/pdf/1812.03982.pdf>

### SUMMARY

### Technical Problem

Therefore, there is a demand for a technology for automatically detecting a non-verbal action and transmitting the non-verbal action to a remote communication counterpart. For example, there has been proposed a technique of inferring a user's motion by a deep neural network constructed by training using supervised data based on moving image data and a correct answer label.

However, the video used as the supervised data for constructing a model for detecting the non-verbal action has various variations including individual differences such as the physique and posture of a target user, environmental information such as a location and a light source, camera photographing conditions for photographing the user, and the presence or absence of an obstacle between the camera and the user. Therefore, capturing a video that comprehensively covers these variations causes an enormous imaging cost.

On the other hand, in Non Patent Literature 1, as a method of generating a large amount of training data of human action estimation from a small source video, a pose of a human body is synthesized by computer graphics (CG) based on a real video of a captured human, and an image is generated from an unseen angle. However, according to the technology of Non Patent Literature 1, since an image generated using CG based on a real video is used as training data, it is difficult to eliminate individual differences of users. Furthermore, in Non Patent Literature 1, environmental information or the like of an environment in which imaging is performed may also affect the training data.

An object of the present disclosure is to provide an information processing apparatus, an information processing method, and an information processing program that enable training of a deep neural network using a small amount of data.

### Solution to Problem

For solving the problem described above, an information processing apparatus according to one aspect of the present disclosure has an abstraction processing unit configured to perform abstraction, from a plurality of directions, on a human body model having three-dimensional information and indicating a first pose associated with a first label, generate a plurality of pieces of first abstracted information each having two-dimensional information and respectively corresponding to the plurality of directions by performing the abstraction, and associate the first label with each of the plurality of pieces of first abstracted information, wherein the plurality of pieces of first abstracted information and second abstracted information having two-dimensional information obtained by abstracting a second pose corresponding to the first pose in one domain are used for associating the first label with the second pose in the one domain.

For solving the problem described above, an information processing apparatus according to one aspect of the present disclosure has an abstraction processing unit configured to perform abstraction on a person included in an input video to generate abstracted information having two-dimensional information; and an inference unit configured to perform inference on a label corresponding to the abstracted information by using a machine learning model, wherein the inference unit performs the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.

### BRIEF DESCRIPTION OF DRAWINGS

FIG. 1 is a schematic diagram schematically illustrating an example of communication in which members actually face each other.

FIG. 2 is a schematic diagram illustrating variations of training video information for training a machine learning model that estimates non-verbal information.

FIG. 3 is a schematic diagram illustrating a configuration of an example of an information processing system according to an embodiment.

FIG. 4 is a schematic diagram illustrating an example of a video chat screen displayed on a display device of a user terminal applicable to the embodiment.

FIG. 5 is a block diagram illustrating a configuration of an example of a server according to the embodiment.

FIG. 6 is a block diagram illustrating a configuration of an example of a learning device applicable to the embodiment.

FIG. 7 is a functional block diagram of an example illustrating functions of a server and the learning device according to the embodiment.

FIG. 8 is a sequence diagram of an example illustrating processing at the time of learning according to the embodiment.

FIG. 9 is a schematic diagram illustrating an example of rendering a human body model by a video rendering unit according to the embodiment.

FIG. 10 is a schematic diagram illustrating abstraction of a video by a skeleton estimation unit according to the embodiment.

FIG. 11 is a schematic diagram illustrating processing in a cloud uploader according to the embodiment.

FIG. 12 is a schematic diagram illustrating a label update process by a 2D abstracted motion correction unit according to the embodiment.

FIG. 13 is a schematic diagram illustrating an occlusion complementing process by the 2D abstracted motion correction unit according to the embodiment.

FIG. 14 is a schematic diagram illustrating generation of a video in an intermediate state between a real video and a CG video by the 2D abstracted motion correction unit according to the embodiment.

FIG. 15 is a sequence diagram of an example illustrating processing in a video chat according to the embodiment.

FIG. 16 is a schematic diagram illustrating a skeleton estimation process and an inference process in a user terminal according to the embodiment.

FIG. 17 is a schematic diagram schematically illustrating processing by a SlowFast network applicable to the embodiment.

FIG. 18 is a schematic diagram illustrating an effect according to the embodiment.

FIG. 19 is a schematic diagram illustrating a first example of other application examples of the technology of the present disclosure.

FIG. 20 is a schematic diagram illustrating a second example of other application examples of the technology of the present disclosure.

FIG. 21 is a schematic diagram illustrating a third example of other application examples of the technology of the present disclosure.

FIG. 22 is a schematic diagram illustrating a fourth example of other application examples of the technology of the present disclosure.

### DESCRIPTION OF EMBODIMENTS

Hereinafter, embodiments of the present disclosure will be described in detail with reference to the drawings. Note that, in the following embodiments, same parts are denoted by same reference signs to omit redundant description.

Hereinafter, the embodiments of the present disclosure will be described in the following order.
1. Background to technology according to present disclosure
2. Embodiment
2-1. Configuration according to embodiment
2-2. Processing according to embodiment
2-2-1. Processing during inference
2-3. Effects of embodiment
2-4. Modification of embodiment
3. Other application examples of technology of the present disclosure

### 1. Background to Technology According to Present Disclosure

Prior to describing an embodiment of the present disclosure, a background to the present disclosure will be schematically described.

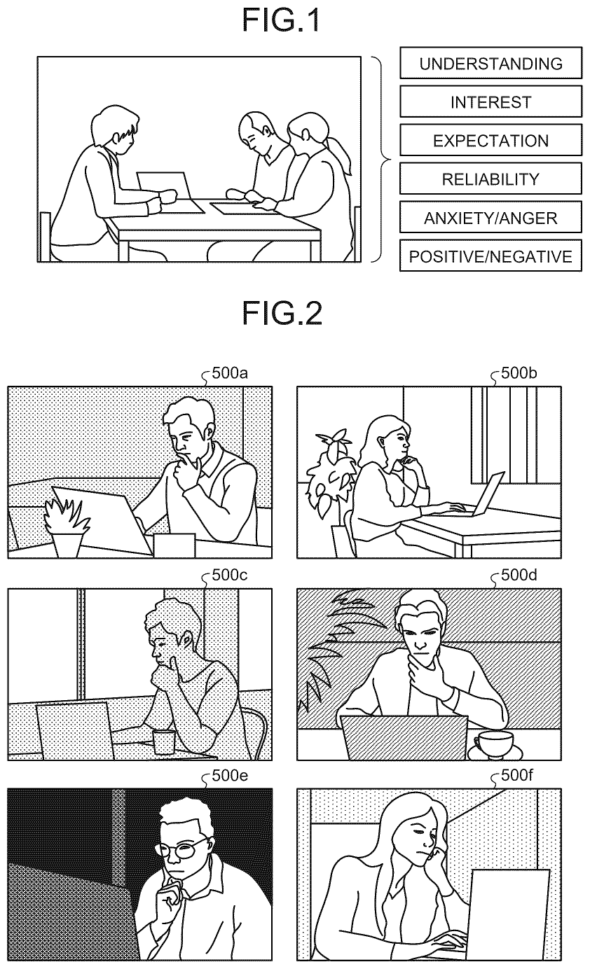

FIG. 1 is a schematic diagram schematically illustrating an example of conventional communication in which members actually face each other (hereinafter referred to as face-to-face communication). In the face-to-face communication, it is known that non-verbal information expressed by atmosphere or nuances, such as member's gesture, expression, and voice tone of speech, is useful communication means in addition to presented materials and utterance content. Such non-linguistic information is referred to as non-verbal information, and communication using the non-verbal information is referred to as non-verbal communication.

For example, in the non-verbal communication, each member may estimate, with respect to an agenda, a degree of understanding, a degree of interest, and a degree of expectation of other members based on the non-verbal information. Furthermore, each member may check reliability of other members or estimate anxiety, anger, and positive or negative emotion of other members based on the non-verbal information.

On the other hand, remote communication is known as a way to communicate with a member in a remote place via a network such as the Internet. As an example, in the remote communication, each of two or more members is connected to a conference server by an information device such as a personal computer. Each member transmits audio information and video information to the conference server by using the information device. Each member can share audio information and video information via the conference server. As a result, it is possible to communicate with a member at a remote location.

In this remote communication, there is an increasing need to detect the non-verbal information of other members. For example, with a progress of machine learning technology represented by deep learning, it has been proposed to apply a technique of estimating, based on video information obtained by capturing a member, a label indicating the non-verbal information of the member to the detection of the non-verbal information.

For example, a member in the remote communication is captured using a camera included in or connected to an information device used for the remote communication. Based on the member's non-verbal information (motion such as tilting neck, holding head, and no reaction) included in a video obtained by capturing the member, a label indicating the non-verbal information (poor concentration, no interest, etc.) is estimated using a machine learning model constructed by machine learning such as a deep neural network. The estimated label is transmitted to other members.

In order to train such a machine learning model for machine learning, a pair of video information and a label for non-verbal information is required as training data. Note that the label refers to answer information that is a correct answer used when the machine learning model is trained by supervised learning.

However, the training video information for training the machine learning model that estimates the non-verbal information includes various variations depending on individual differences such as the physique and posture of the subject, background information such as a location, environmental information such as a light source, the position and characteristics (angle of view, etc.) of the camera, and the presence of an obstacle.

FIG. 2 is a schematic diagram illustrating variations of training video information for training the machine learning model that estimates the non-verbal information. In patterns 500a to 500f illustrated in FIG. 2, different users show the same non-verbal information in different environments. In the patterns 500a to 500f, it is assumed that each user is in a pose of resting an elbow near a notebook personal computer, and this non-verbal action of “resting the elbow” corresponds to a label “concentrating”.

In FIG. 2, in the patterns 500a, 500c, 500d, and 500e, each user places his/her hand on his/her chin, whereas in the patterns 500b and 500f, each user places his/her hand on his/her cheek. In addition, in each of the patterns 500a to 500f, the background and the brightness of the user are different, and the presence of window, the presence of interior decoration, and the like in the background are different. As described above, even when the user takes a non-verbal action of “resting one's elbow near the notebook personal computer” corresponding to the label “concentrating”, there are various variations in the video. Therefore, even in the same pose, different camera videos are obtained depending on a user as a subject or an imaging environment.

Here, a large amount of training data can be obtained by comprehensively capturing all the patterns as illustrated in the patterns 500a to 500f. However, comprehensive imaging of each pattern in order to prepare training data involves enormous imaging cost. Furthermore, in order to configure a classifier in machine learning, it is necessary to prepare training data based on negative information, and this also involves enormous imaging cost.

On the other hand, in Non Patent Literature 1, as a method of obtaining a large amount of training data for estimating a human behavior from a small source video, a pose of a human body is synthesized by computer graphics (CG) based on a video (real video) obtained by capturing the subject, and an image from an unseen angle is generated. However, according to the technology of Non Patent Literature 1, since the image generated using the CG based on the real video is used as the training data, it is difficult to eliminate the individual user difference, and there is also a possibility that the environmental information of the environment in which the image is captured and the like affects the training data.

### 2. Embodiment

Next, an embodiment of the present disclosure will be described. In the embodiment of the present disclosure, a data expansion process is performed to expand training data prepared based on a small amount of input video based on a camera video captured using a camera by using video information obtained by abstracting a human body model having three-dimensional information. Here, data expansion means generation of a large amount of data corresponding to certain source data.

More specifically, in the embodiment of the present disclosure, a human body model having three-dimensional information indicating a first pose associated with a first label is rendered into an image having two-dimensional information from a plurality of directions, and each rendered video is abstracted to generate a plurality of pieces of first abstracted information. Video abstraction is performed, for example, by detecting an object corresponding to a human body included in the video and extracting a skeleton from the detected object.

In the embodiment of the present disclosure, second abstracted information having two-dimensional information obtained by abstracting a second pose corresponding to the first pose in one domain is further generated. Here, the domain refers to a specific action (non-verbal action) by a specific user. For example, a series of motions related to the specific action by specific user A may configure one domain. As an example, when the specific action is an action of “resting one's chin on one's hand” by the user A, a series of motions from a predetermined start point of the action to completion of the action may configure one domain.

In other words, in the embodiment of the present disclosure, a pose (second pose) by an actual person corresponding to a certain pose (first pose) by the human body model is abstracted to generate second abstracted information. For example, when the first pose is a pose of “resting one's chin on one's hand”, the pose of “resting one's chin on one's hand” by the actual person may be the second pose corresponding to the first pose.

The first label is associated with the second pose in the one domain based on the second abstracted information and the plurality of pieces of first abstracted information described above. More specifically, the first label is associated with the second pose in the one domain by the machine learning model trained using the plurality of pieces of first abstracted information and the second

In the embodiment of the present disclosure, this makes it possible to obtain a large amount of training data associated with a predetermined label based on a small amount of video information in one domain.

### 2-1. Configuration According to Embodiment

Next, a configuration according to the embodiment will be described.

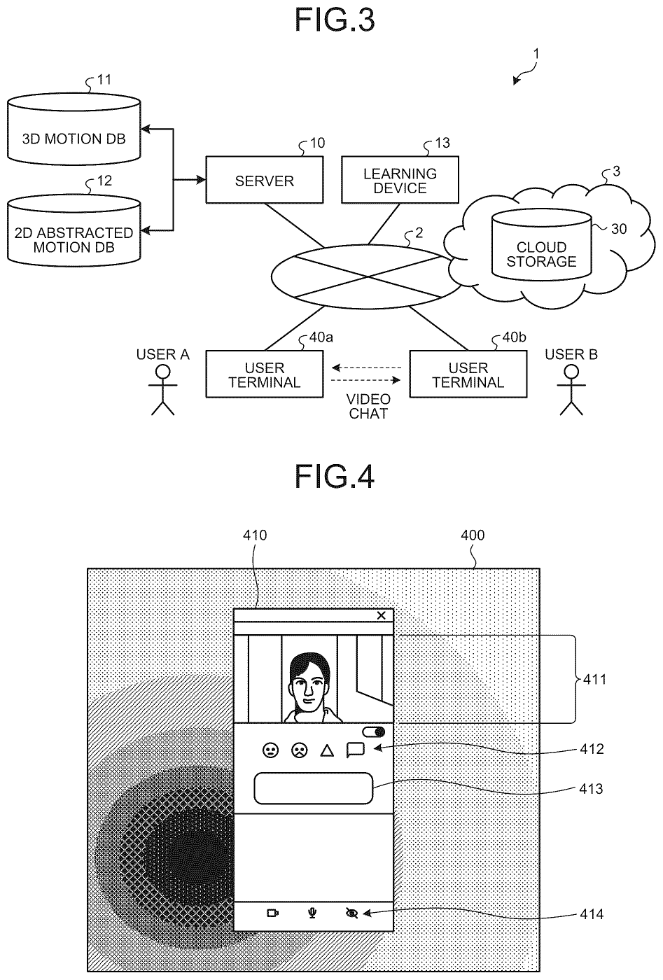

FIG. 3 is a schematic diagram illustrating a configuration of an example of the information processing system according to the embodiment. In FIG. 3, the information processing system 1 includes a server 10, a learning device 13, and user terminals 40a and 40b that are communicably connected to the Internet 2. In addition, a three-dimensions (3D) motion database (DB) and a two-dimensions (2D) abstracted motion DB 12 are connected to the server 10.

Note that, in FIG. 3, the server 10 is illustrated as being configured by independent hardware, but this is not limited to the example. For example, the server 10 may be configured by distributing functions by a plurality of computers communicably connected to each other.

Here, an information device such as a general personal computer or a tablet computer may be applied to the user terminals 40a and 40b. Each of the user terminals 40a and 40b has a built-in or connected camera, and can transmit a video captured using the camera to the Internet 2. Furthermore, each of the user terminals 40a and 40b has a built-in microphone or is connected to the microphone, and can transmit voice data of voice collected by the microphone to the Internet 2. Furthermore, in the user terminals 40a and 40b, a pointing device such as a mouse or an input device such as a keyboard is built in or connected, and information such as text data input using the input device can be transmitted to the Internet 2.

Note that, for the sake of explanation, it is assumed that the user A uses the user terminal 40a and a user B uses the user terminal 40b.

In addition, a cloud network 3 is connected to the Internet 2. The cloud network 3 includes a plurality of computers and storage devices communicably connected to each other via a network, and is a network capable of providing computer resources in the form of services.

The cloud network 3 includes a cloud storage 30. The cloud storage 30 is a storage location of files used via the Internet 2, and can share files stored in the storage location by sharing a uniform resource locator (URL) indicating the storage location on the cloud storage 30. In the example in FIG. 3, the cloud storage 30 can share files among the server 10, the learning device 13, and the user terminals 40a and 40b.

Note that, in FIG. 3, a 3D motion DB 11 and a 2D abstracted motion DB 12 are illustrated as being directly connected to the server 10, but this is not limited to the example. The 3D motion DB 11 and the 2D abstracted motion DB 12 may be connected to the server 10 via the Internet 2. Furthermore, in FIG. 3, the learning device 13 is illustrated as being configured by individual hardware, but this is not limited to the example. For example, one or both of the user terminals 40a and 40b may include the function of the learning device 13, or the server 10 may include the function of the learning device 13.

In addition, FIG. 3 illustrates that the information processing system 1 includes two user terminals 40a and 40b, but this is for the sake of explanation. The information processing system 1 may include three or more user terminals.

In FIG. 3, the user A and the user B can perform video chat via the Internet 2 using the user terminal 40a and user terminal 40b, respectively. Here, the chat refers to real-time communication using a data communication line on a computer network including the Internet. The video chat refers to a chat using a video. For example, the user A and the user B respectively use the user terminal 40a and the user terminal 40b to access a chat server (not illustrated) that provides a video chat service via the Internet 2.

For example, the user A transmits a video obtained by capturing the user A with a camera of the user terminal 40a to the chat server via the Internet 2. The user B accesses the chat server by the user terminal 40b, and acquires the video transmitted from the user terminal 40a to the chat server. Video transmission from the user terminal 40b to the user terminal 40a is performed in a similar manner. As a result, the user A and the user B can communicate with each other remotely using the user terminal 40a and the user terminal 40b while watching the video according to the video transmitted from each other.

The video chat is not limited to an example performed between the two user terminals 40a and 40b. The video chat can also be performed among three or more user terminals.

Furthermore, although details will be described later, in the embodiment, the user terminal 40a can detect a non-verbal action by the user A based on a video obtained by capturing the user A with the camera, and transmit non-verbal information indicating the detected non-verbal action to the user terminal 40b via the chat server. The non-verbal information is transmitted as, for example, a label associated with the non-verbal action. By causing the user terminal 40b to display the non-verbal information transmitted from the user terminal 40a, the user B can acquire the non-verbal action by the user A. The same applies to the user terminal 40b.

Note that, in the following description, when it is not necessary to particularly distinguish the user terminal 40a and the user terminal 40b, the user terminal 40 will be described as a representative. Furthermore, in the following description of the video chat, description of processing related to the chat server is omitted, and description is made such that information is transmitted from the user terminal 40a to the user terminal 40b.

FIG. 4 is a schematic diagram illustrating an example of a video chat screen displayed on a display device of the user terminal 40 that is applicable to the embodiment. In FIG. 4, a video chat screen 410 is displayed on a display screen 400 of the display device. In the example in FIG. 4, the video chat screen 410 includes a video display area 411, a non-verbal information display area 412, an input area 413, and a media control area 414.

In the video display area 411, a video based on a video transmitted from a video chat partner is displayed. For example, the video display area 411 displays the video of the partner captured by the user terminal 40 of the video chat partner. When the video chat is performed by three or more user terminals 40, the video display area 411 can simultaneously display two or more videos. In addition, the video display area 411 can display not only a captured video but also a still image based on still image data such as a document image.

The non-verbal information display area 412 displays the non-verbal information transmitted from the video chat partner. In the example in FIG. 4, the non-verbal information is displayed as an icon image indicating the non-verbal action. The non-verbal information indicated here may include, for example, implicit expressions of the user including feeling, emotion, and nuances of the user, such as “concentrating”, “having a question”, “agreeing”, “having an opposing opinion”, “distracted”, “bored”, and the like. In addition, in the example in FIG. 4, the non-verbal information display area 412 indicates the non-verbal information as an icon image, but this is not limited to the example. The non-verbal information may be displayed as, for example, text information.

The input area 413 is an area for inputting text data for performing a chat (text chat) using text information. Furthermore, the media control area 414 is an area for setting whether or not transmission of a video captured by the camera and transmission of audio data collected using the microphone can be performed in the user terminal 40.

Note that the configuration of the video chat screen 410 illustrated in FIG. 4 is an example, and is not limited to the example.

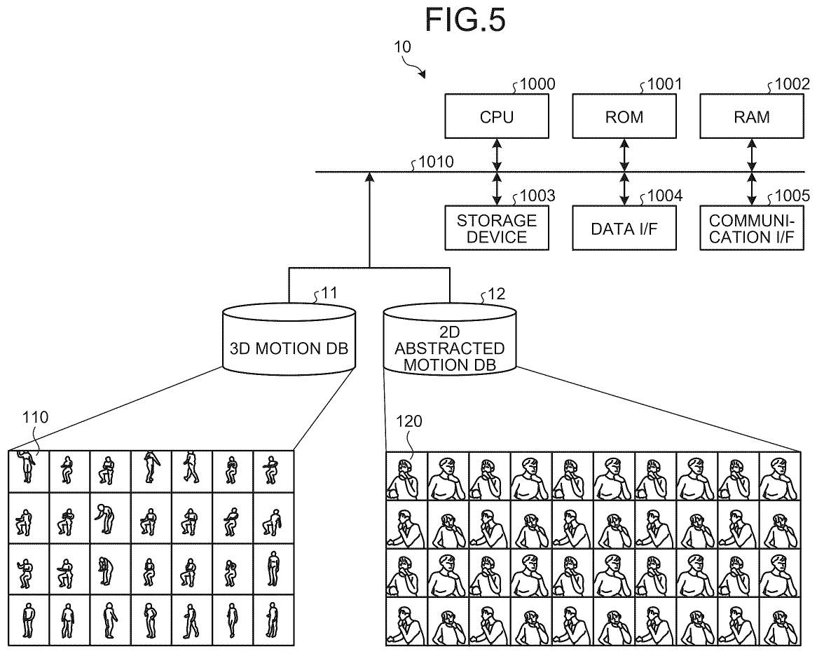

FIG. 5 is a block diagram illustrating a configuration of an example of the server 10 according to the embodiment. In the example in FIG. 5, the server 10 includes a central processing unit (CPU) 1000, a read only memory (ROM) 1001, a random access memory (RAM) 1002, a storage device 1003, a data interface (I/F) 1004, and a communication I/F 1005 that are communicably connected to each other via a bus 1010.

The storage device 1003 is a nonvolatile storage medium such as a hard disk drive or a flash memory. Note that the storage device 1003 may be configured outside the server 10. A CPU 1000 controls the entire operation of the server 10 by using the RAM 1002 as a work memory according to a program stored in the ROM 1001 and the storage device 1003.

The data I/F 1004 is an interface for transmitting and receiving data to and from an external device. An input device such as a keyboard may be connected to the data I/F 1004. The communication I/F 1005 is an interface for controlling communication with respect to a network such as the Internet 2.

Furthermore, the 3D motion DB 11 and the 2D abstracted motion DB 12 are connected to the server 10. In the example in FIG. 4, for the sake of explanation, the 3D motion DB 11 and the 2D abstracted motion DB 12 are illustrated to be connected to the bus 1010, but this is not limited to the example. For example, the 3D motion DB 11 and the 2D abstracted motion DB 12 may be connected to this server 10 via a network including the Internet 2.

The 3D motion DB 11 stores a human body model

110. The human body model 110 is, for example, data representing a standard human body configuration including a head, a body, and four limbs by three-dimensional information, and is capable of representing at least movement of main joints of the human body. Furthermore, the 3D motion DB 11 stores a plurality of poses of the human body model 110 that the human body model 110 is possible to take including a short motion related to each of the plurality of poses. The pose taken by the human body model 110 may be information integrally indicating the state of each part of the human body model 110. Furthermore, each of the plurality of poses is associated with a label indicating the pose. As an example, the human body model 110 indicating the motion of resting one's chin on one's hand while sitting on the chair includes a short motion (e.g., several seconds) for performing the motion of resting one's chin on one's hand, and a label “resting one's chin on one's hand” indicating the motion is associated.

Hereinafter, the label indicating the operation is referred to as a motion label as appropriate. In addition, a label attached to the meaning of the operation indicated by the motion label is referred to as a semantic label as appropriate. As an example, when the action of “resting one's chin on one's hand” means “concentrating”, the motion label may be “resting one's chin on one's hand”, and the semantic label may be “concentrating”.

The 2D abstracted motion DB 12 stores, for each human body model 110 of each pose stored in the 3D motion DB 11, a 2D abstracted video 120 having two-dimensional information obtained by abstracting each video obtained by virtually capturing a human body model from multiple directions. Abstraction of the human body model 110 can be realized by, for example, detecting the skeleton of the human body model 110 from a video having two-dimensional information that virtually captures the human body model 110 including motion. Each 2D abstracted video 120 stored in the 2D abstracted motion DB 12 is a video having two-dimensional information, including an operation in the human body model 110. In addition, each 2D abstracted video 120 is associated with the motion label associated with a source human body model 110.

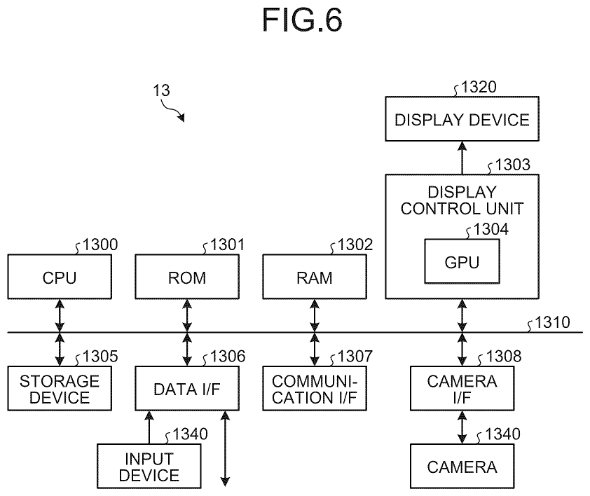

FIG. 6 is a block diagram illustrating a configuration of an example of the learning device 13 applicable to the embodiment. The configuration illustrated in FIG. 6 is also applicable to the user terminal 40. In FIG. 6, the learning device 13 includes a CPU 1300, a ROM 1301, a RAM 1302, a display control unit 1303, a storage device 1305, a data I/F 1306, a communication I/F 1307, and a camera I/F 1308 that are communicably connected to each other via a bus 1310.

The storage device 1305 is a nonvolatile storage medium such as a hard disk drive or a flash memory. The CPU 1300 operates using the RAM 1302 as a work memory according to a program stored in the storage device 1305 and the ROM 1301, and controls the entire operation of the learning device 13.

The display control unit 1303 includes a graphics processing unit (GPU) 1304, performs image processing using the GPU 1304 as necessary based on display control information generated by the CPU 1300, for example, and generates a display signal supportable by a display device 1320. The display device 1320 displays a screen indicated in the display control information according to the display control signal supplied from the display control unit 1303.

Note that the GPU 1304 included in the display control unit 1303 is not limited to image processing based on the display control information, and can also execute, for example, a learning process of a machine learning model using a large amount of training data, an inference process using a machine learning model, and the like.

The data I/F 1306 is an interface for transmitting and receiving data to and from an external device. In addition, an input device 1330 such as a keyboard may be connected to the data I/F 1306. The communication I/F 1307 is an interface for controlling communication with the Internet 2.

The camera I/F 1308 is an interface for transmitting and receiving data to and from a camera 1313. The camera 1313 may be built in the learning device 13 or may be an external device for the learning device 13. The camera 1313 may also be configured to be connected to the data I/F 1306. The camera 1313 captures an image and outputs the image, for example, under the control of the CPU 1300.

When the configuration of the learning device 13 in FIG. 6 is applied to the user terminal 40, a microphone and a voice processing unit that executes signal processing on a voice collected by the microphone may be added to the configuration in FIG. 6.

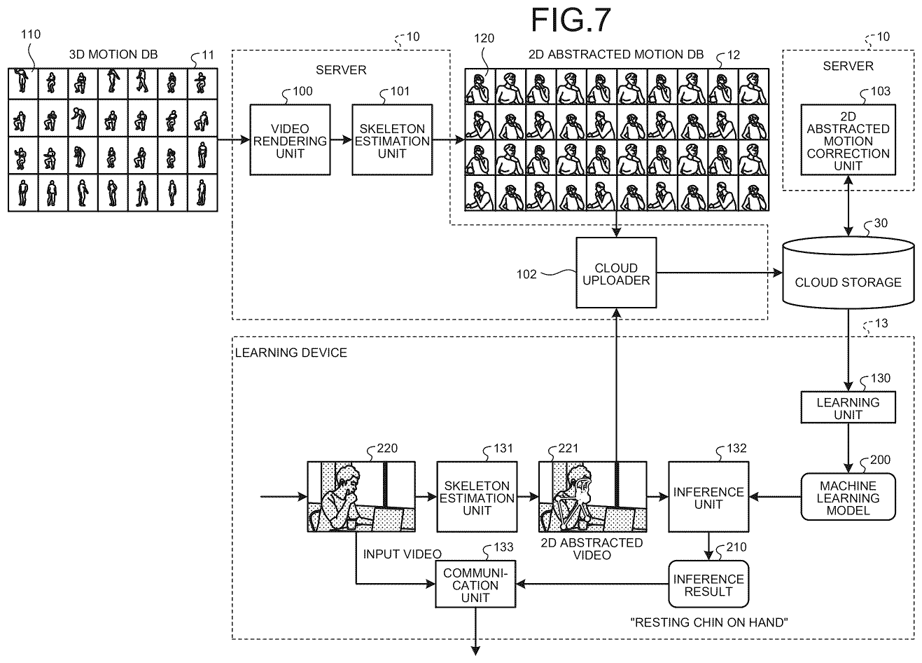

FIG. 7 is a functional block diagram of an example illustrating functions of the server 10 and the learning device 13 according to the embodiment. In FIG. 7, the server 10 includes a video rendering unit 100, a skeleton estimation unit 101, a cloud uploader 102, and a 2D abstracted motion correction unit 103.

The video rendering unit 100, the skeleton estimation unit 101, the cloud uploader 102, and the 2D abstracted motion correction unit 103 are implemented by the CPU 1000 executing the information processing program for the server according to the embodiment. Not limited thereto, a part or all of the video rendering unit 100, the skeleton estimation unit 101, the cloud uploader 102, and the 2D abstracted motion correction unit 103 may be realized by a hardware circuit that operates in cooperation with each other.

The learning device 13 includes a learning unit 130, a skeleton estimation unit 131, an inference unit 132, and a communication unit 133. Note that the learning device 13 may omit the inference unit 132. The skeleton estimation unit 131, the inference unit 132, and the communication unit 133 are implemented by a CPU 4000 executing an information processing program for the learning device according to the embodiment. Not limited thereto, part or all of the learning unit 130, the skeleton estimation unit 131, the inference unit 132, and the communication unit 133 may be realized by a hardware circuit that operates in cooperation with each other.

In the server 10, the video rendering unit 100 renders the human body model 110 stored in the 3D motion DB 11 from a plurality of directions to generate a video based on the two-dimensional information. The skeleton estimation unit 101 estimates the skeleton of the human body model 110 included in the video for each video in which the human body model 110 is rendered from a plurality of directions by the video rendering unit 100. The skeleton estimation unit 101 stores each piece of information indicating an estimated skeleton in the 2D abstracted motion DB 12 as a 2D abstracted video 120 obtained by abstracting the human body model 110, in association with the motion label (e.g., “resting one's chin on one's hand”) of the source human body model 110.

In other words, the skeleton estimation unit 101 functions as an abstraction processing unit that generates the plurality of pieces of first abstracted information each having the two-dimensional information obtained by abstracting the human body model from a plurality of directions based on the human body model having the three-dimensional information and indicating the first pose associated with the first label, and associates the first label with each of the plurality of pieces of first abstracted information.

On the other hand, in the learning device 13, the skeleton estimation unit 131 detects a person included in an input video 220 using, for example, a video captured by the camera 1340 as the input video 220. The skeleton estimation unit 131 estimates a skeleton of the person detected from the input video 220. Information indicating the skeleton estimated by the skeleton estimation unit 101 is transmitted to the server 10 as a 2D abstracted video 221 obtained by abstracting the person included in the input video 220, and is passed to the inference unit 132. Since this 2D abstracted video 221 is a video generated from the input video 220 that is a real video, it may be referred to as the 2D abstracted video 221 based on the real video.

In the server 10, the cloud uploader 102 uploads data to the cloud storage 30. The data uploaded to the cloud uploader 102 is stored in the cloud storage 30 so as to be accessible from the server 10 and the learning device 13. More specifically, the server 10 uploads each 2D abstracted video 120 by the human body model 110 and the 2D abstracted video 221 based on the real video transmitted from the learning device 13 to the cloud storage 30.

In the server 10, the 2D abstracted motion correction unit 103 combines each 2D abstracted video 120 based on the human body model 110 and the 2D abstracted video 221 based on the real video stored in the cloud storage 30 to expand the 2D abstracted video 221 based the real video. In other words, the 2D abstracted motion correction unit 103 combines the 2D abstracted video 221 based on the real video and the 2D abstracted video 120 based on the human body model 110, so that it is possible to obtain a large amount of abstracted videos (referred to as an expanded abstracted video) corresponding to the 2D abstracted videos 221 based on the real video. The 2D abstracted motion correction unit 103 stores the expanded abstracted video in the cloud storage 30.

The learning device 13 acquires each expanded abstracted video from the cloud storage 30. In the learning device 13, a machine learning model 200 is trained using each expanded abstracted video acquired from the cloud storage 30. As the machine learning model 200, for example, a deep neural network model may be applied. The learning device 13 stores trained machine learning model 200 in, for example, the storage device 1305. Not limited thereto, the learning device 13 may store the machine learning model 200 in the cloud storage 30. For example, the learning device 13 may transmit the machine learning model 200 to the user terminal 40 in response to a request from the user terminal 40.

Note that, when the configuration of the learning device 13 is applied to the user terminal 40, the learning unit 130 can be omitted. In addition, using the machine learning model 200, the inference unit 132 executes the inference process of inferring a label of the 2D abstracted video 221 whose skeleton is estimated from the input video 220 by the skeleton estimation unit 131. The inference unit 132 passes an inference result 210 of the inference (e.g., motion label “resting one's chin on one's hand”) to the communication unit 133. The input video 220 is further passed to the communication unit 133. The communication unit 133 associates the input video 220 and the inference result 210 and sends it to, for example, the user terminal 40 of the video chat partner.

The user terminal 40 includes the skeleton estimation unit 131, the inference unit 132, and the communication unit 133. The skeleton estimation unit 131, the inference unit 132, and the communication unit 133 are implemented by the CPU 4000 executing an information processing program for the user terminal device according to the embodiment. Not limited thereto, part or all of the skeleton estimation unit 131, the inference unit 132, and the communication unit 133 may be realized by a hardware circuit that operates in cooperation with each other.

In the server 10, the CPU 1000 executes the information processing program for the server according to the embodiment, thereby configuring each of the video rendering unit 100, the skeleton estimation unit 101, and the 2D abstracted motion correction unit 103 described above as, for example, a module on a main storage region in the RAM 1002.

The information processing program can be acquired externally via, for example, the Internet 2 by communication via the communication I/F 1006 and installed on the server 10. Not limited thereto, the information processing program may be provided by being stored in a detachable storage medium such as a compact disk (CD), a digital versatile disk (DVD), or a universal serial bus (USB) memory.

Furthermore, in the learning device 13, the CPU 1300 executes the information processing program for the learning device to configure each of the learning unit 130, the skeleton estimation unit 131, the inference unit 132, and the communication unit 133 described above as, for example, a module on a main storage region in the RAM 1302.

The information processing program can be acquired externally via, for example, the Internet 2 by communication via the communication I/F 1307, and installed on the learning device 13. Not limited thereto, the information processing program may be provided by being stored in a detachable storage medium such as a compact disk (CD), a digital versatile disk (DVD), or a universal serial bus (USB) memory.

Similarly, in the user terminal 40, the CPU 1300 executes the information processing program for the user terminal, thereby configuring each of the skeleton estimation unit 131, the inference unit 132, and the communication unit 133 described above as, for example, a module on a main storage region in the RAM 1302.

The information processing program can be acquired externally via, for example, the Internet 2 by communication via the communication I/F 1307, and installed on the user terminal 40. Not limited thereto, the information processing program may be provided by being stored in a detachable storage medium such as a compact disk (CD), a digital versatile disk (DVD), or a universal serial bus (USB) memory.

### 2-2. Processing According to Embodiment

Next, processing according to the embodiment will be described in more detail.

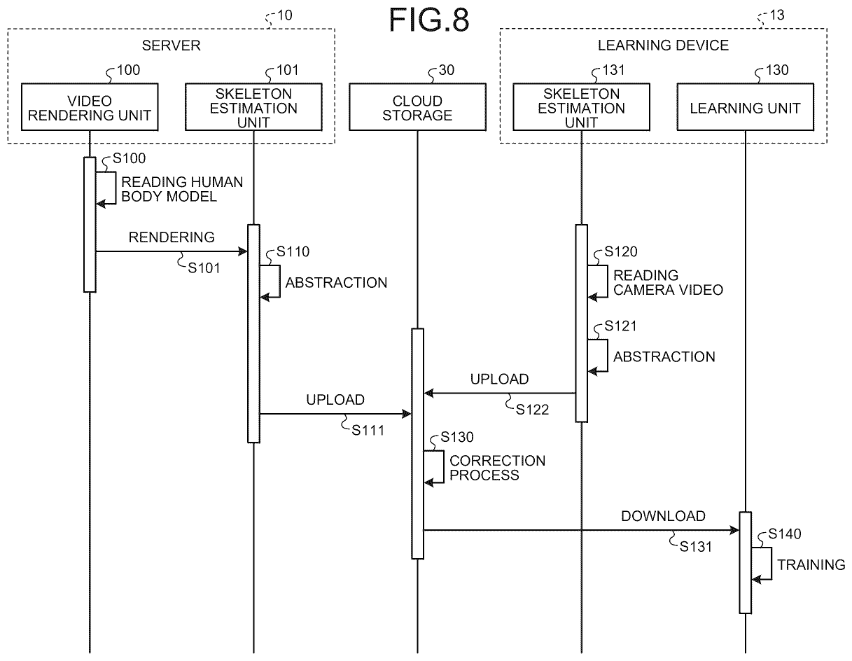

FIG. 8 is a sequence diagram illustrating an example of a learning process according to the embodiment. Prior to the process in FIG. 8, each human body model 110 stored in the 3D motion DB 11 is created. For example, the human body model 110 indicating a pose that can be taken by the user as the non-verbal action is created for a quantity corresponding to types of the non-verbal action by the user. Each human body model 110 includes a short motion (e.g., several seconds) related to a pose. A motion label corresponding to each pose is added to each human body model 110 created. Each human body model 110 to which the motion label is added is stored in the 3D motion DB 11.

In FIG. 8, in Step S100, the video rendering unit 100 in the server 10 reads, for example, one human body model 110 from the 3D motion DB 11. The pose taken by the human body model 110 corresponds to the first pose described above. In Step S101, the video rendering unit 100 renders the human body model 110 read into a video having the two-dimensional information from the plurality of directions, and passes each rendered video to the skeleton estimation unit 101.

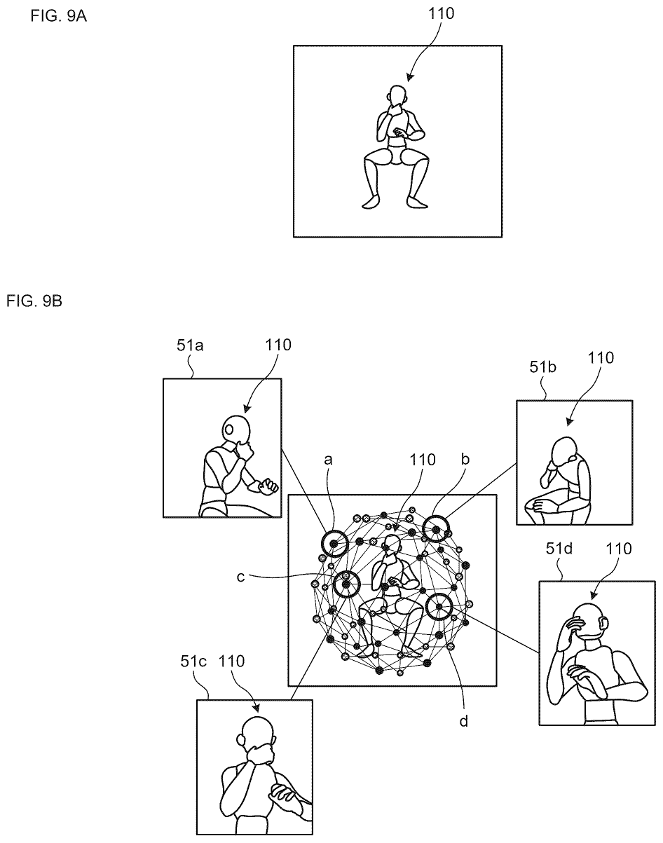

FIG. 9 is a schematic diagram illustrating an example of rendering the human body model 110 by the video rendering unit 100 according to the embodiment. As illustrated in section (a) of FIG. 9, a human body model 110 of an arbitrary pause motion (e.g., pose motion of “resting one's chin on one's hand”) is prepared. Note that the pose motion includes a short action related to the pose taken by the human body model 110. The human body model 110 may use a motion model generally published and sold.

As illustrated in section (b) of FIG. 9, the video rendering unit 100 arranges virtual cameras in a plurality of directions, for example, in a spherical shape with respect to the human body model 110. In the section (b) of FIG. 9, an arrangement example of the camera with respect to the human body model 110 is illustrated at the center of the drawing. The video rendering unit 100 virtually captures the human body model 110 from capturing positions at a plurality of positions and distances in a range of 360° in each of upper, lower, left, and right directions, and renders the human body model into short moving images. The number of capturing positions is preferably as large as possible, and for example, about several to ten thousands may be set in a spherical shape.

In the example in the section (b) of FIG. 9, at a position a, the human body model 110 is captured at an angle 51a illustrated in an upper left. Similarly, at positions b to d, the human body model 110 is captured at angles 51b, 51c, and 51d, respectively.

Returning to the description of FIG. 8, in Step S110, the skeleton estimation unit 101 abstracts, in the server 10, the video obtained by capturing and rendering the human body model 110 from the plurality of directions and received from the video rendering unit 100. More specifically, the skeleton estimation unit 101 abstracts the video having the two-dimensional information by detecting the skeleton of the human body model 110 included in the video.

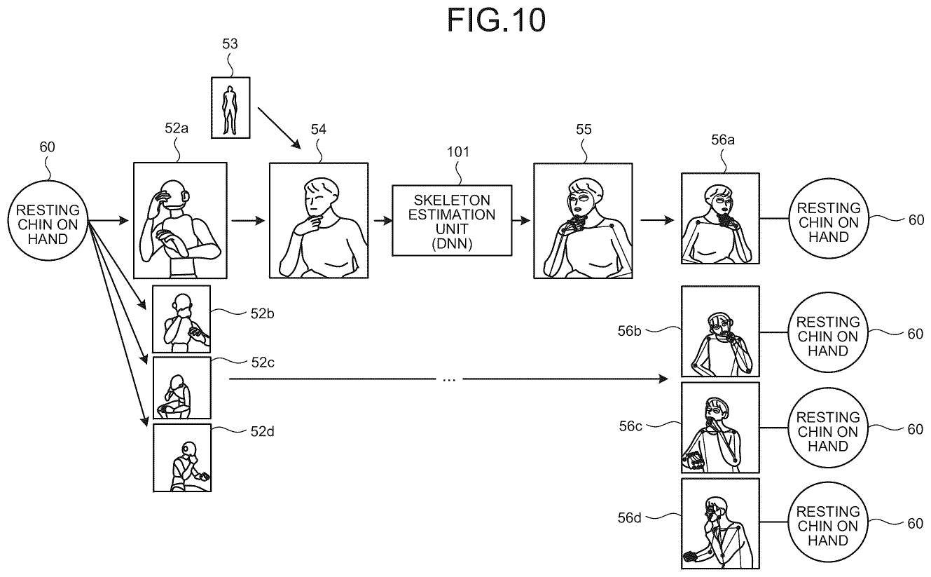

FIG. 10 is a schematic diagram illustrating video abstraction by the skeleton estimation unit 101 according to the embodiment. In FIG. 10, examples of rendered videos 52a to 52d in which the human body model 110 of a predetermined pose (first pose) is rendered from a plurality of directions by the video rendering unit 100 are illustrated on the left side. Each of the rendered videos 52a to 52d is associated with an arbitrary label related to the source human body model 110. In the example in FIG. 10, each of the rendered videos 52a to 52d is associated with a motion label 60 (“resting one's chin on one's hand”) indicating an action related to the pose of the source human body model 110.

Since the skeleton estimation unit 101 executes common processing for each of the rendered videos 52a to 52d, here, the description will be given using the rendered video 52a as an example among the rendered videos 52a to 52d.

The skeleton estimation unit 101 assigns an arbitrary realistic CG model 53 to the rendered video 52a and generates the rendered video 54. The skeleton estimation unit 101 applies an arbitrary skeleton estimation model to the rendered video 54 to estimate skeleton information for each frame of the rendered video 54. The skeleton estimation unit 101 may perform skeleton estimation using, for example, a deep neural network (DNN). As an example, the skeleton estimation unit 101 may perform the skeleton estimation on the rendered video 54 using a skeleton estimation model by a known technique called OpenPose.

In the embodiment, since the realistic CG model 53 is assigned to the rendered video 52a, the skeleton estimation unit 101 can execute the skeleton estimation using a general skeleton estimation model.

The skeleton estimation unit 101 generates the motion video 56a of the skeleton information 55 by associating the motion label 60 of the source human body model 110 of the skeleton information 55 in which the skeleton is estimated for each frame of the rendered video 54. The skeleton estimation unit 101 further executes this process on each of the rendered videos 52b to 52d captured from a direction different from the rendered video 52a, and generates motion videos 56b to 56d of skeleton information from each direction by respectively associating the motion labels 60 of the source human body model 110. Each of the motion videos 56a to 56d is an abstracted video obtained by abstracting the source human body model 110 based on the skeleton information.

The skeleton estimation unit 101 stores each of the motion videos 56a to 56d in the 2D abstracted motion DB 12 as the 2D abstracted video 120 having two-dimensional information. Each 2D abstracted video 120 stored in the 2D abstracted motion DB 12 is uploaded from the cloud uploader 102 to the cloud storage 30 (Step S111).

Returning to the description in FIG. 8, in the learning device 13, the skeleton estimation unit 131 reads, as the input video 220, a camera video obtained by capturing a user's pose by the camera 1340 as one domain (Step S120). The user's pose included in the input video 220 includes a short motion related to the pose. The input video 220 may include, for example, a second pose by the person corresponding to the first pose of the human body model 110 read by the video rendering unit 100 in Step $100. For example, when the first pose of the human body model 110 is the pose of “resting one's chin on one's hand”, the input video 220 is a video obtained by capturing the pose of “resting one's chin on one's hand” performed by the user.

The input video 220 is associated with the motion label related to the pose performed by the user. At this time, a semantic label indicating a meaning related to the user's pose may be associated with the input video 220. The skeleton estimation unit 131 performs skeleton estimation on the input video 220 read to abstract the input video 220 (Step S121). As a method of the skeleton estimation by the skeleton estimation unit 131, the above-described method of skeleton estimation in the skeleton estimation unit 101 of the server 10 can be applied. The skeleton estimation unit 101 transmits the 2D abstracted video 221 obtained by abstracting the input video 220 to the server 10 together with the motion label associated with the source input video 220. The server 10 uploads, by the cloud uploader 102, the 2D abstracted video 221 and the motion label transmitted from the skeleton estimation unit 101 to the cloud storage 30 (Step S122).

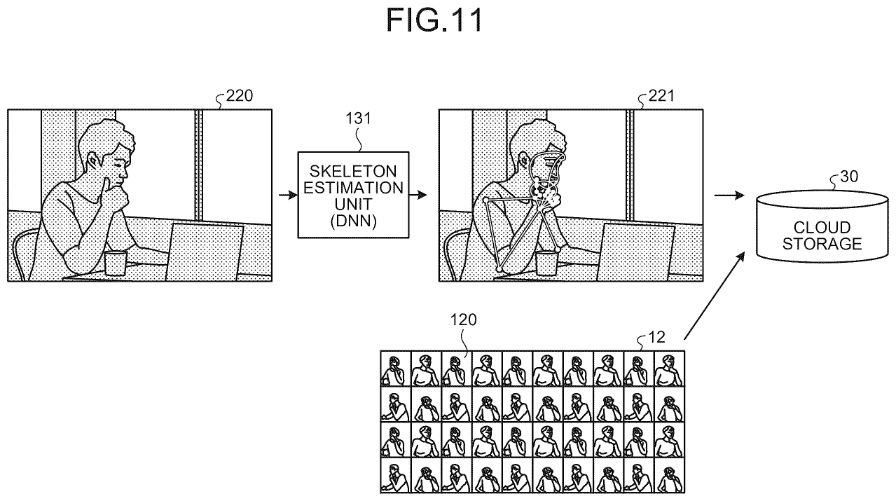

FIG. 11 is a schematic diagram illustrating processing in the cloud uploader 102 according to the embodiment. The cloud uploader 102 uploads, to the cloud storage 30, each of the 2D abstracted videos 120 stored in the 2D abstracted motion DB and associated with a common motion label. In addition, the cloud uploader 102 uploads, to the cloud storage 30, the 2D abstracted video 221 associated with the motion label in which the input video 220 is subjected to skeleton estimation and abstraction by the skeleton estimation unit 131.

As a result, the 2D abstracted video 221 and the plurality of 2D abstracted videos 120 are associated with each other, and thus the motion labels of the plurality of 2D abstracted videos 120 can be associated with actions included in the 2D abstracted video 221, i.e., source input video 220 of the 2D abstracted video 221.

Here, the learning device 13 acquires the camera video for each of a plurality of domains. For example, the user takes a plurality of different poses according to a role play. At this time, the user may be, for example, a user different from the users A and B who perform the video chat using the user terminals 40a and 40b. The learning device 13 captures each pose as one domain by the camera 1340 to acquire a plurality of input videos 220. Each of the plurality of acquired input videos 220 is associated with the motion label related to the pose. The number of actions performed by the user is not particularly limited, but about several 10 to 100 is preferable to support various non-verbal actions.

The learning device 13 executes skeleton estimation for each input video 220 collected for each domain by the skeleton estimation unit 101, and generates the 2D abstracted video 221 in which each domain is abstracted. This 2D abstracted video 221 is uploaded to the cloud storage 30 by the cloud uploader 102. Since the 2D abstracted video 221 is generated by abstracting the input video 220 according to the skeleton estimation, personal information included in the input video 220 is removed. Therefore, it is possible to upload the 2D abstracted videos 120 and 221 to the cloud storage 30 and manage them in a centralized manner without distinguishing a CG video or a real video in a state where the personal information is removed.

Returning to FIG. 8, in the server 10, the 2D abstracted motion correction unit 103 executes a correction process on the 2D abstracted videos 120 and 221 uploaded and stored in the cloud storage 30 (Step S130).

The following three examples are given as examples of the correction process executed by the 2D abstracted motion correction unit 103 include.
(1) Label update
(2) Complementing occlusion
(3) Generation of intermediate video between real video and CG video

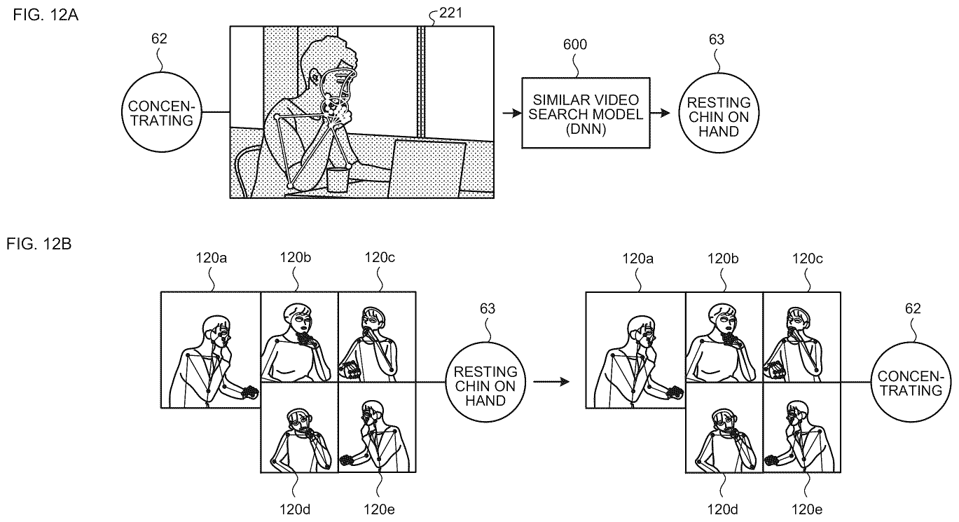

First, (1) Label update will be described. FIG. 12 is a schematic diagram illustrating a label update process by the 2D abstracted motion correction unit 103 according to the embodiment. Section (a) in FIG. 12 schematically illustrates an example of a case of searching for a video similar to a small number of 2D abstracted videos 221 associated with domain-specific semantic labels 62 (“concentrated”).

In the case of the section (a) of FIG. 12, for example, the 2D abstracted motion correction unit 103 searches a video similar to the 2D abstracted video 221 from the 2D abstracted motion DB 12, for example, using an arbitrary similar video search model 600. As a result, one or more 2D abstracted videos 120 and a motion label 63 (“resting one's chin on one's hand”) associated with the 2D abstracted video 120 are obtained as a search result. In the example in FIG. 12, as illustrated on the left side of the section (b), a plurality of 2D abstracted videos 120a to 120e each associated with the motion label 63 (“resting one's chin on one's hand”) is obtained as the search result.

As illustrated in the section (b) of FIG. 12, the 2D abstracted motion correction unit 103 changes the motion label 63 (“resting one's chin on one's hand)” associated with each of the 2D abstracted videos 120a to 120e to a semantic label 62 (“concentrating”) associated with the 2D abstracted video 221 that is a search source. For example, the semantic label 62 may be designated for the input video 220 at acquiring the input video 220. The 2D abstracted motion correction unit 103 can acquire the semantic label 62 based on the 2D abstracted video 221 stored in the cloud storage 30. The 2D abstracted motion correction unit 103 updates each of the 2D abstracted videos 120a to 120e stored in the 2D abstracted motion DB 12 using the semantic label 62 changed.

For all the 2D abstracted videos 120 stored in the 2D abstracted motion DB 12, by changing the motion label 63 to the semantic label 62 associated with the corresponding 2D abstracted video 221, a data set for inferring a domain-specific semantic label. 62 can be expanded.

Next, (2) Complementing occlusion will be described. Occlusion means that, in an image or the like, an object in front of an object of interest hides a part or all of the object of interest.

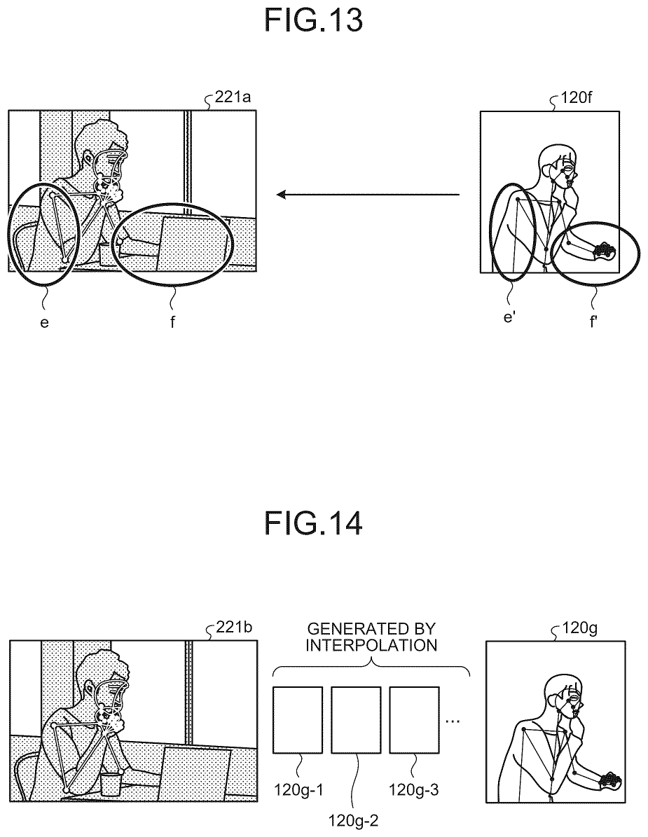

FIG. 13 is a schematic diagram illustrating an occlusion complementing process by the 2D abstracted motion correction unit 103 according to the embodiment. In FIG. 13, a 2D abstracted video 221a based on a real video illustrated on the left side is hidden by a right arm portion, as indicated by a range e, and it is difficult to detect a body skeleton. Similarly, in the 2D abstracted video 221a, it is difficult to detect a skeleton of a left hand portion, as indicated by a range f, due to a cover of a notebook computer. As described above, in the 2D abstracted video 221a, occlusion occurs in the ranges e and f.

On the other hand, as illustrated on the right side of FIG. 13, occlusion does not occur in a 2D abstracted video 221a obtained by abstracting the human body model 110 corresponding to the 2D abstracted video 120f. Therefore, the 2D abstracted motion correction unit 103 automatically complements the skeleton information of the ranges e and f of the 2D abstracted video 221a by using the skeleton information in the ranges e′ and f′ corresponding to the ranges e and f of the 2D abstracted video 221a in the 2D abstracted video 120f.

Next, (3) Generation of intermediate video between real video and CG video will be described. FIG. 14 is a schematic diagram illustrating generation of the intermediate video between the real video and the CG video by the 2D abstracted motion correction unit 103 according to the embodiment. For example, the 2D abstracted motion correction unit 103 searches, from the 2D abstracted motion DB 12, a 2D abstracted video 221b similar to the 2D abstracted video 120g based on the real video. Note that it is assumed that the 2D abstracted video 221b is associated with a semantic label (e.g., “concentrating”) unique to the domain.

The 2D abstracted motion correction unit 103 interpolates between respective key points (feature points) of the 2D abstracted video 221b and the 2D abstracted video 120g searched. As a result, one or more poses in an intermediate state between the pose indicated by the 2D abstracted video 221b and the pose indicated by the 2D abstracted video 120g can be generated, and one or more 2D abstracted videos 120g-1, 120g-2, 120g-3, and so on based on each generated pose can be obtained.

The 2D abstracted motion correction unit 103 stores the generated 2D abstracted videos 120g-1, 120g-2, 120g-3, and so on in the 2D abstracted motion DB 12 in association with a domain-specific semantic label (e.g., “concentrating”). This can expand a data set for inferring domain-specific semantic labels.

Returning to FIG. 8, after the correction process by the 2D abstracted motion correction unit 103 in Step S130, each 2D abstracted video 120 subjected to the correction process and the 2D abstracted video 221 corresponding to the 2D abstracted video 120 are downloaded from the cloud storage 30 by the learning device 13 (Step S131).

In the learning device 13, the learning unit 130 trains the machine learning model. 200 by using the 2D abstracted videos 120 downloaded from the cloud storage 30 and the 2D abstracted videos 221 each corresponding to the 2D abstracted video 120 (Step S140). For example, the learning unit 130 causes the machine learning model 200 to learn the semantic label associated with the 2D abstracted video 221 as correct answer data.

The machine learning model 200 trained in Step S140 is transmitted to the user terminals 40a and 40b, for example, in response to a request from the user terminals 40a and 40b.

### 2-2-1. Processing During Inference

Next, processing at the time of inference according to the embodiment will be described. For example, when a video chat is performed between user terminals, the non-verbal information of the counterpart is mutually inferred from each other based on camera videos transmitted from the counterpart's user terminals.

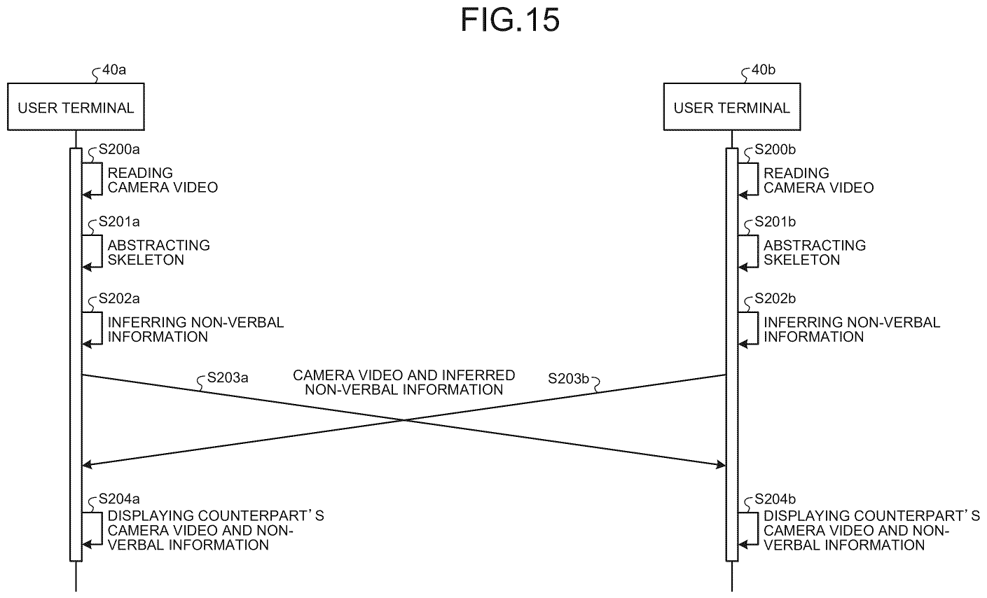

FIG. 15 is a sequence diagram of an example illustrating processing in the video chat according to the embodiment. Here, it is assumed that the video chat is performed between the user terminal 40a and the user terminal 40b illustrated in FIG. 3. In addition, it is assumed that the user terminals 40a and 40b have the machine learning model 200 trained by the learning unit 130 in the learning device 13. For example, the user terminals 40a and 40b store, in the storage device 1305, the machine learning model 200 acquired from the learning device 13 via the Internet 2.

Furthermore, it is assumed that each of the user terminals 40a and 40b has a configuration corresponding to the learning device 13 illustrated in FIG. 6, and the function also includes the skeleton estimation unit 131, the inference unit 132, and the communication unit 133 in the learning device 13 illustrated in FIG. 7.

In FIG. 15, in Step S200a, the user terminal 40a reads a camera video obtained by capturing a user A with the camera 1340 as the input video 220. The user terminal 40a estimates a skeleton of the user A included in the input video 220 read by the skeleton estimation unit 131 to generate the 2D abstracted video 221 and abstract the information on the user A (Step S201a). The 2D abstracted video 221 in which the information on the user A is abstracted is passed to the inference unit 132.

In the user terminal 40a, the inference unit 132 applies the 2D abstracted video 221 received from the skeleton estimation unit 131 to the machine learning model 200 to infer the non-verbal information by the user A (Step S202a). The user terminal 40a transmits, by the communication unit 133, the non-verbal information inferred in Step S202a and a camera video (input video 220) captured by the camera 1340 to the user terminal 40b (Step S203a).

The user terminal 40b receives the non-verbal information and the camera video transmitted from the user terminal 40a. The user terminal 40b causes the display device 1320 to display the non-verbal information and the camera video received. As described with reference to FIG. 4, the user terminal 40b displays the non-verbal information in the non-verbal information display area 412 as, for example, an icon image. Further, the user terminal 40b displays the camera video in the video display area 411.

Since processes in Steps S200b to S203b in the user terminal 40b is similar to the processes in Steps S200a to S203a in the user terminal 40a, detailed description thereof will be omitted here. Similarly, the processing in the user terminal 40a that has received the non-verbal information and the camera video from the user terminal 40b in Step S203b is also similar to the processing in Step S204b in the user terminal 40b, and thus the detailed description thereof will be omitted here.

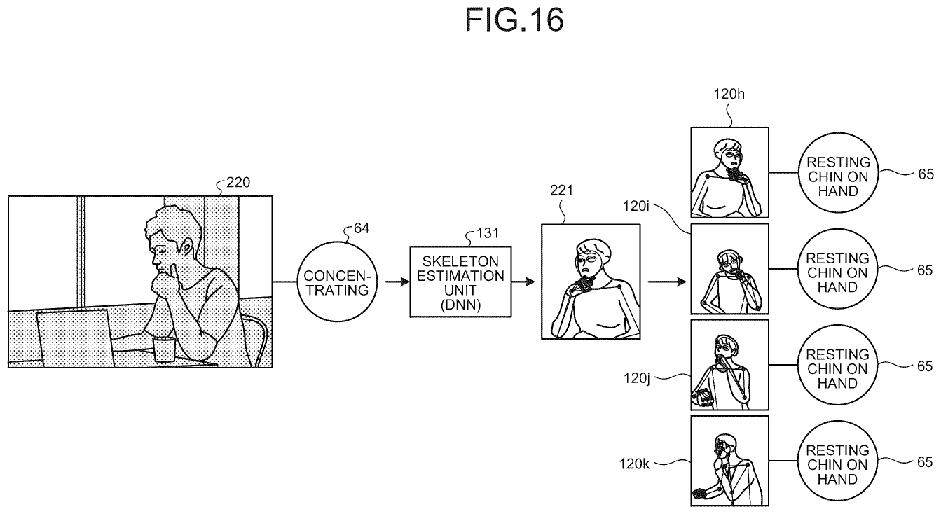

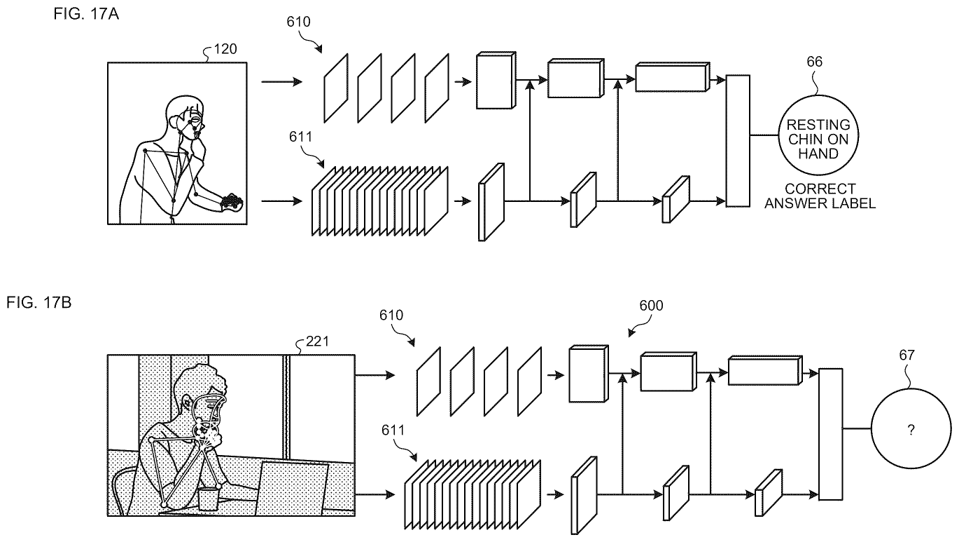

FIG. 16 is a schematic diagram illustrating a skeleton estimation process and the inference process in the user terminal 40 according to the embodiment. For example, it is assumed that the user A performs a motion corresponding to a semantic label 64 (“concentrating”) indicating “concentrating” and the motion is captured by the camera 1340 of the user terminal 40. In the user terminal 40, the skeleton estimation unit 131 reads the input video 220 of a motion camera video, captured by the camera 1340, corresponding to the semantic label 64. The skeleton estimation unit 131 applies an arbitrary skeleton estimation model to the read input video 220 to estimate a skeleton, and generates the 2D abstracted video 221 obtained by abstracting the input video 220. The skeleton estimation unit 131 passes the 2D abstracted video 221 generated to the inference unit 132.

Based on the 2D abstracted video 221 received from the skeleton estimation unit 131, the inference unit 132 searches a video similar to the 2D abstracted video 120 from the 2D abstracted videos 221 stored in the 2D abstracted motion DB 12, for example, using an arbitrary similar video search model 600. The machine learning model 200 according to the embodiment may be applied to the similar video search model 600. Note that, here, for the sake of explanation, it is assumed that the 2D abstracted motion DB 12 stores 2D abstracted videos 120h to 120k each associated with a motion label 65 (“resting one's chin on one's hand”).

The similar video search model. 600 returns, to the inference unit 132, the motion label 65 indicating “resting one's chin on one's hand” associated with the searched video (referred to as a 2D abstracted video 120i) as the motion label corresponding to the input video 220.

In other words, it can be said that the machine learning model 200 can infer the motion label corresponding to the 2D abstracted video 221 based on the 2D abstracted video 221.

The user terminal 40 transmits the motion label 65 acquired by the inference unit 132 from the similar video search model 600 and the input video 220 to the user terminal 40 of the video chat partner.

As the similar video search model 600, it is possible to apply a SlowFast network (see Non Patent Literature 2) that is one of deep learning models trained using a pair of the training video and the motion label to estimate the label when an arbitrary video is received.

FIG. 17 is a schematic diagram schematically illustrating processing by the SlowFast network applicable to the embodiment. In FIG. 17, a section (a) illustrates an example of processing at the time of learning by the SlowFast network, and a section (b) illustrates an example of processing at a time of inference by the SlowFast network. As described in detail in Non Patent Literature 2, the similar video search model 600 using the SlowFast network includes a first path 610 in which a frame rate is decreased and a spatial feature amount is emphasized, and a second path 611 in which the frame rate is increased and the temporal feature amount is emphasized.

At the time of learning, as illustrated in the section (a) of FIG. 17, the learning unit 130 inputs each of the 2D abstracted videos 120 downloaded from the cloud storage 30 and the 2D abstracted videos 221 corresponding to the 2D abstracted videos 120 to the first path 610 and the second path 611 of the similar video search model 600. The learning unit 130 trains the similar video search model 600 by using these 2D abstracted videos 120 and 221 and a correct answer label 66.

At the time of inference, the inference unit 132 inputs the 2D abstracted video 221 in which the skeleton information is estimated by the skeleton estimation unit 131 based on the input video 220 captured by the camera 1340 to the first path 610 and the second path 611 of the similar video search model 600 as illustrated in the section (b) of FIG. 17. The inference unit 132 infers a correct answer label 67 based on outputs of the first path 610 and the second path 611.

### 2-3. Effects of Embodiment

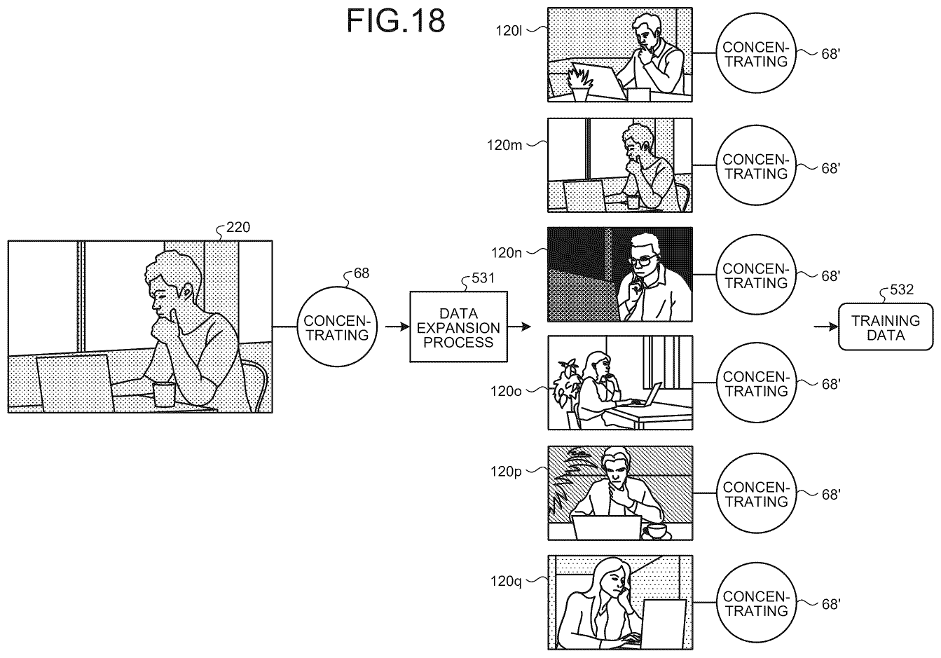

Next, effects of the embodiment will be described. FIG. 18 is a schematic diagram illustrating an effect according to the embodiment.

In the information processing system 1 according to the embodiment, a small amount of the input video 220 in which a semantic label 68 corresponding to the motion is associated with the camera video captured and collected by performing actions corresponding to the plurality of states by the role play or the like is prepared. The information processing system 1 abstracts the input video 220 prepared by the skeleton estimation or the like, and performs a data expansion process 531 according to the embodiment described with reference to FIGS. 7 to 14 by using the 2D abstracted video 221 generated by abstracting the input video 220 prepared by the skeleton estimation or the like by abstracting the input video and the plurality of 2D abstracted videos 120 obtained by rendering and abstracting the human body model 110 having three-dimensional information from the plurality of directions.

With this data expansion process 531, the information processing system 1 can expand the 2D abstracted video 221 based on the source input video 220, and can obtain a large amount of abstracted videos by expansion associated with a semantic label 68′ corresponding to the semantic labels 68 of the source input video 220 (illustrated as 2D abstracted videos 120l to 120g in FIG. 18). These abstracted videos obtained by a large amount of expansion are used as training data 532 for training the machine learning model 200.

As described above, in the embodiment, when the data including the motion of the person specialized in the domain is collected as the training data of the machine learning model, it is not necessary to collect an enormous amount of motions assuming a plurality of states. Therefore, it is possible to drastically reduce the cost of collecting the training data.

### 2-4. Modification of Embodiment

A modification of the embodiment will be described. In the above description, it has been described that the user A and the user B participating in the video chat transmit and receive the non-verbal information in both directions, but this is not limited to the example. In other words, the embodiment can be similarly applied to a case where the non-verbal information is transmitted in one direction from the user A or the user B to the other party of the video chat.

For example, when positions of members participating in the video chat are not equal, transmission of the non-verbal information may be limited to one direction. As an example where the positions of the members participating in the video chat are not equal, a customer and a life planner, an interviewer and an interviewee in an interview, and the like can be considered. In the video chat between the customer and the life planner, for example, the customer may transmit the non-verbal information to the life planner in one direction. In the example of the interview using the video chat, the non-verbal information may be transmitted in one direction from the interviewee to the interviewer.

Furthermore, the embodiment can be applied to a remote consulting system that remotely provides consultation. In this case, the side receiving consultation (customer) may transmit the non-verbal information in one direction to the side providing the consultation. In addition, the embodiment can also be applied to an insurance system in which consultation or contract of life insurance or the like is performed remotely. In this case, an insured person or a customer may transmit the non-verbal information to the person in charge of the life insurance in one direction.

In the embodiment, since the non-verbal information is inferred by the machine learning model trained using a large amount of training data expanded based on a small amount of abstracted information, it is possible to support an arbitrary customer.

### 3. Other Application Examples of Technology of the Present Disclosure

Another application example of the technology of the present disclosure will be described. In the above-described embodiment, it has been described that the technology of the present disclosure is applied to detection and transmission of the non-verbal information in the video chat. However, the technology of the present disclosure is also applicable to other fields. In other words, the technology of the present disclosure is applicable not only to human motions but also to other fields where abstraction is possible. As other fields that can be abstracted, data collection of facial expression, data collection of iris, data collection of pose (posture) by the whole human body, data collection of hand, and the like can be considered.

A first example of other application examples of the technology of the present disclosure will be described. The first example of other application examples of the technology of the present disclosure is an example in which the technology of the present disclosure is applied to collection of training data used for training a machine learning model for inferring a facial expression.

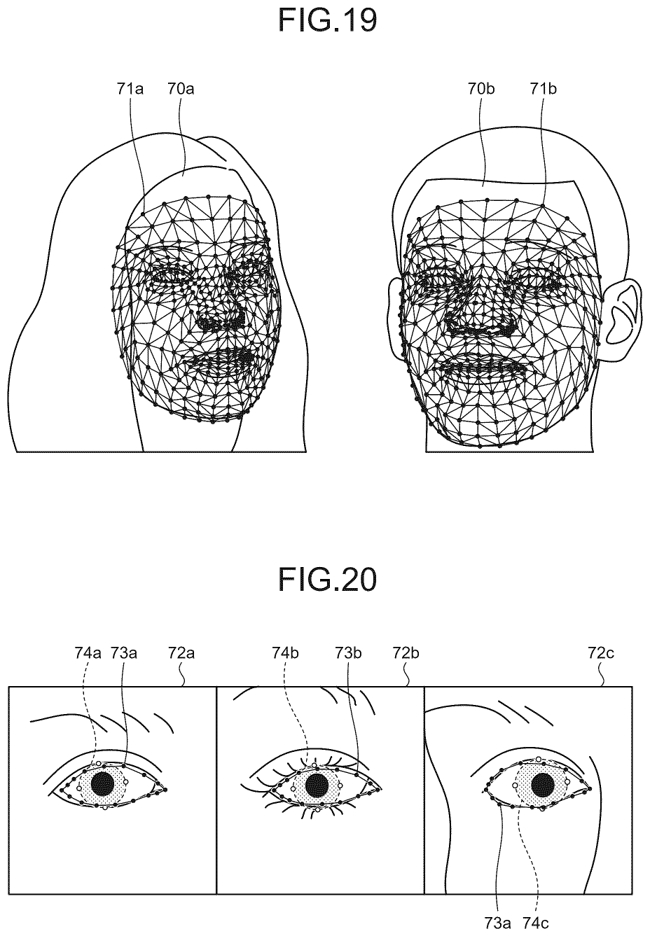

FIG. 19 is a schematic diagram illustrating the first example of other application examples of the technology of the present disclosure. Faces 70a and 70b can be abstracted by meshes 71a and 71b in which vertices are associated with points on surfaces of the faces 70a and 70b, respectively. For example, an expression of the face 70a can be inferred based on the mesh 71a. In training data for training a machine learning model used for this inference, the mesh 71a as abstracted data obtained by abstracting a source face 70a is expanded by the data expansion process according to the present disclosure, and meshes 71a by a large number of expressions are generated. The training data is used for training the machine learning model that infers the expression of the face 70a by associating a label with each of the meshes 71a based on the large number of expressions.

A second example of other application examples of the technology of the present disclosure will be described. The second example of other application examples of the technology of the present disclosure is an example in which the technology of the present disclosure is applied to collection of training data used for training a machine learning model for inferring a state (position or the like) of an iris.

FIG. 20 is a schematic diagram illustrating the second example of other application examples of the technology of the present disclosure. In images 72a to 72c, the state of the iris can be abstracted by contour information 74a to 74c based on a predetermined point of the contour of the iris included in eyes 73a, 73b, and 73c detected as the contour. In training data for training a machine learning model used for the inference, for example, contour information 74a as abstracted data obtained by abstracting the iris in the eye 73a is expanded by the data expansion process according to the present disclosure, and the contour information 74a based on a large number of states of iris is generated. The training data is used for training a machine learning model for inferring the state of the iris in the eye 73a by associating a label with each of the contour information 74a according to a large number of states.

A third example of other application examples of the technology of the present disclosure will be described. The third example of other application examples of the technology of the present disclosure is an example in which the technology of the present disclosure is applied to collection of training data used for training a machine learning model for inferring a pose by the entire human body.

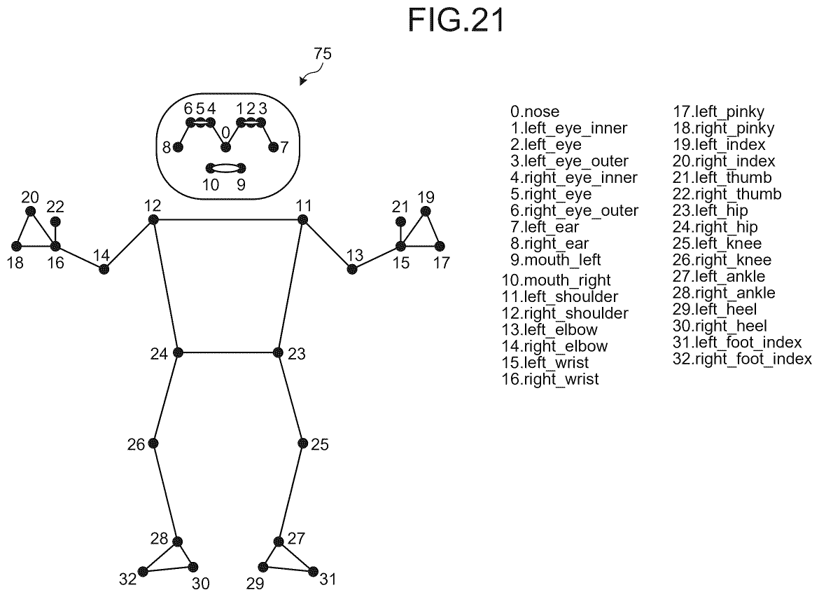

FIG. 21 is a schematic diagram illustrating the third example of other application examples of the technology of the present disclosure. In FIG. 21, the left side illustrates an example of abstracted data 75 obtained by abstracting the entire human body. The right side of FIG. 21 illustrates a name of body corresponding to the number attached to each point of the abstracted data 75. By detecting the position of each point included in the abstracted data 75, it is possible to infer the pose of a person abstracted by the abstracted data 75. Training data for training a machine learning model used for the inference, i.e., the abstracted data 75, is expanded by the data expansion process according to the present disclosure, and pose information based on a large number of poses is generated. The training data is used for training the machine learning model that infers the pose of the person abstracted by the abstracted data 75 by associating a label with each piece of pose information based on the large number of poses.

A fourth example of other application examples of the technology of the present disclosure will be described. The fourth example of other application examples of the technology of the present disclosure is an example in which the technology of the present disclosure is applied to collection of training data used for training a machine learning model for inferring a hand state.

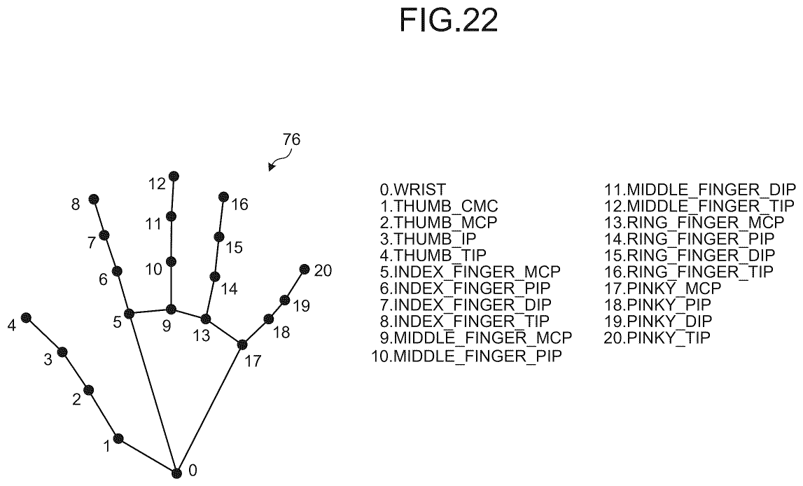

FIG. 22 is a schematic diagram illustrating the fourth example of other application examples of the technology of the present disclosure. In FIG. 22, the left side illustrates an example of abstracted data 76 obtained by abstracting a hand. The right side of FIG. 22 illustrates the name of each part of the hand corresponding to the number assigned to each point of the abstracted data 76. By detecting the position of each point included in the abstracted data 76, it is possible to infer the hand state abstracted by the abstracted data 76. Training data for training the machine learning model used for the inference, i.e., the abstracted data 76, is expanded by the data expansion process according to the present disclosure, and state information based on a large number of hand states is generated. The training data is used to train the machine learning model that infers the hand state abstracted by the abstracted data 76 by associating a label with each of the state information based on the large number of hand states.

Note that the effects described in the present specification are merely examples and not limited, and other effects may be provided.

The present technology may also have the following configurations.
(1) An information processing apparatus comprising
   an abstraction processing unit configured to perform abstraction, from a plurality of directions, on a human body model having three-dimensional information and indicating a first pose associated with a first label, generate a plurality of pieces of first abstracted information each having two-dimensional information and respectively corresponding to the plurality of directions by performing the abstraction, and associate the first label with each of the plurality of pieces of first abstracted information, wherein
   the plurality of pieces of first abstracted information and second abstracted information having two-dimensional information obtained by abstracting a second pose corresponding to the first pose in one domain are used for associating the first label with the second pose in the one domain.
(2) The information processing apparatus according to the above (1), wherein
   the abstraction processing unit
   performs the abstraction by estimating skeleton information of the human body model.
(3) The information processing apparatus according to the above (1) or (2), wherein
   the abstraction processing unit
   generates the plurality of pieces of first abstracted information each including the motion based on the human body model including a motion.
(4) The information processing apparatus according to any one of the above (1) to (3), wherein
   the abstraction processing unit
   generates the plurality of pieces of first abstracted information based on an image obtained by performing rendering of the human body model from the plurality of directions.
(5) The information processing apparatus according to the above (4), wherein
   the human body model is a model that can express at least a movement of a human joint, and the abstraction processing unit
   performs the rendering by applying a model virtually reproducing a human to the human body model.
(6) The information processing apparatus according to any one of the above (1) to (5), further comprising
   a correction unit configured to correct the plurality of pieces of first abstracted information or the second abstracted information based on the plurality of pieces of first abstracted information and the second abstracted information.
(7) The information processing apparatus according to the above (6), wherein
   the correction unit
   changes the first label associated with each of the plurality of pieces of first abstracted information to a second label associated with the second pose in the one domain.
(8) The information processing apparatus according to the above (6) or (7), wherein
   the correction unit
   complements information missing in the second abstracted information due to occlusion, based on the first abstracted information generated based on the human body model indicating the first pose corresponding to the second pose, among the plurality of pieces of first abstracted information.
(9) The information processing apparatus according to any one of the above (6) to (8), wherein
   the correction unit
   generates one or more pieces of abstracted information on an intermediate state between a state indicated by the first abstracted information and a state indicated by the second abstracted information, the abstracted information on the intermediate state being generated using the second abstracted information and the first abstracted information generated based on the human body model indicating the first pose corresponding to the second pose, among the plurality of pieces of first abstracted information, and adds the one or more intermediate states generated to the plurality of pieces of first abstracted information.
(10) The information processing apparatus according to any one of the above (1) to (9), further comprising
   a learning unit configured to associate the first label with the second pose in the one domain by a machine learning model trained using the plurality of pieces of first abstracted information and the second abstracted information.
(11) An information processing method executed by a processor, the information processing method comprising
   an abstraction processing step of performing abstraction, from a plurality of directions, on a human body model having three-dimensional information and indicating a first pose associated with a first label, generating a plurality of pieces of first abstracted information each having two-dimensional information and respectively corresponding to the plurality of directions by performing the abstraction, and associating the first label with each of the plurality of pieces of first abstracted information, wherein
   the plurality of pieces of first abstracted information and second abstracted information having two-dimensional information obtained by abstracting a second pose corresponding to the first pose in one domain are used for associating the first label with the second pose in the one domain.
(12) An information processing program causing a processor to implement
   an abstraction processing step of performing abstraction, from a plurality of directions, on a first pose having three-dimensional information and associated with a first label, generating a plurality of pieces of first abstracted information each having two-dimensional information and respectively corresponding to the plurality of directions by performing the abstraction, and associating the first label with each of the plurality of pieces of first abstracted information, wherein
   the plurality of pieces of first abstracted information and second abstracted information having two-dimensional information obtained by abstracting a second pose corresponding to the first pose in one domain are used for associating the first label with the second pose in the one domain.
(13) An information processing apparatus comprising:
   an abstraction processing unit configured to perform abstraction on a person included in an input video to generate abstracted information having two-dimensional information; and
   an inference unit configured to perform inference on a label corresponding to the abstracted information by using a machine learning model, wherein
   the inference unit
   performs the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.
(14) The information processing apparatus according to the above (13), wherein
   the abstraction processing unit
   performs the abstraction by estimating skeleton information of the person.
(15) The information processing apparatus according to the above (13) or (14), wherein
   the inference unit
   searches, from the plurality of pieces of first abstracted information, the first pose similar to a pose estimated from the skeleton information of the person, and acquires the label associated with the first pose searched as a result of the inference.
(16) The information processing apparatus according to any one of the above (13) to (15), further comprising
   a communication unit configured to transmit the input video and the label.
(17) An information processing method executed by a processor, the information processing method comprising:
   an abstraction processing step of performing abstraction on a person included in an input video to generate abstracted information having two-dimensional information; and
   an inference step of performing inference on a label corresponding to the abstracted information by using a machine learning model, wherein
   the inference step
   executes the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.
(18) An information processing program causing a processor to implement:
   an abstraction processing step of performing abstraction on a person included in an input video to generate abstracted information having two-dimensional information; and
   an inference step of performing inference on a label corresponding to the abstracted information by using a machine learning model, wherein
   the inference step
   executes the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.

### REFERENCE SIGNS LIST

1 INFORMATION PROCESSING SYSTEM
2 INTERNET
3 CLOUD NETWORK
10 SERVER
11 3D MOTION DB
12 2D ABSTRACTED MOTION DB
13 LEARNING DEVICE
30 CLOUD STORAGE
40, 40a, 40b USER TERMINAL
52a, 52b, 52c, 52d, 54 RENDERED VIDEO
55 SKELETON INFORMATION
56a, 56b, 56c, 56d MOTION VIDEO
53 CG MODEL
60, 63, 65 MOTION LABEL
62, 64, 68, 68′ SEMANTIC LABEL
66, 67 CORRECT ANSWER LABEL
100 VIDEO RENDERING UNIT
101, 131 SKELETON ESTIMATION UNIT
102 CLOUD UPLOADER
103 2D ABSTRACTED MOTION CORRECTION UNIT
130 LEARNING UNIT
132 INFERENCE UNIT
133 COMMUNICATION UNIT
110 HUMAN BODY MODEL
120, 120a, 120b, 120c, 120d, 120e, 120f, 120g, 120g-1, 120g-2, 120g-3, 120h, 120i, 120j, 120l, 120m, 120n, 120o, 120p, 120q, 221, 221a, 221b 2D ABSTRACTED VIDEO
200 MACHINE LEARNING MODEL
210 INFERENCE RESULT
220 INPUT VIDEO
410 VIDEO CHAT SCREEN
411 VIDEO DISPLAY AREA
412 NON-VERBAL INFORMATION DISPLAY AREA
413 INPUT AREA
414 MEDIA CONTROL AREA
531 DATA EXPANSION PROCESS
532 TRAINING DATA
600 SIMILAR VIDEO SEARCH MODEL
1304 GPU
1340 CAMERA

1. An information processing apparatus comprising
an abstraction processing unit configured to perform abstraction, from a plurality of directions, on a human body model having three-dimensional information and indicating a first pose associated with a first label, generate a plurality of pieces of first abstracted information each having two-dimensional information and respectively corresponding to the plurality of directions by performing the abstraction, and associate the first label with each of the plurality of pieces of first abstracted information, wherein
the plurality of pieces of first abstracted information and second abstracted information having two-dimensional information obtained by abstracting a second pose corresponding to the first pose in one domain are used for associating the first label with the second pose in the one domain.

2. The information processing apparatus according to claim 1, wherein
the abstraction processing unit
performs the abstraction by estimating skeleton information of the human body model.

3. The information processing apparatus according to claim 1, wherein
the abstraction processing unit
generates the plurality of pieces of first abstracted information each including the motion based on the human body model including a motion.

4. The information processing apparatus according to claim 1, wherein
the abstraction processing unit
generates the plurality of pieces of first abstracted information based on an image obtained by performing rendering of the human body model from the plurality of directions.

5. The information processing apparatus according to claim 4, wherein
the human body model is a model that can express at least a movement of a human joint, and the abstraction processing unit
performs the rendering by applying a model virtually reproducing a human to the human body model.

6. The information processing apparatus according to claim 1, further comprising
a correction unit configured to correct the plurality of pieces of first abstracted information or the second abstracted information based on the plurality of pieces of first abstracted information and the second abstracted information.

7. The information processing apparatus according to claim 6, wherein
the correction unit
changes the first label associated with each of the plurality of pieces of first abstracted information to a second label associated with the second pose in the one domain.

8. The information processing apparatus according to claim 6, wherein
the correction unit
complements information missing in the second abstracted information due to occlusion, based on the first abstracted information generated based on the human body model indicating the first pose corresponding to the second pose, among the plurality of pieces of first abstracted information.

9. The information processing apparatus according to claim 6, wherein
the correction unit
generates one or more pieces of abstracted information on an intermediate state between a state indicated by the first abstracted information and a state indicated by the second abstracted information, the abstracted information on the intermediate state being generated using the second abstracted information and the first abstracted information generated based on the human body model indicating the first pose corresponding to the second pose, among the plurality of pieces of first abstracted information, and adds the one or more intermediate states generated to the plurality of pieces of first abstracted information.

10. The information processing apparatus according to claim 1, further comprising
a learning unit configured to associate the first label with the second pose in the one domain by a machine learning model trained using the plurality of pieces of first abstracted information and the second abstracted information.

11. An information processing method executed by a processor, the information processing method comprising
an abstraction processing step of performing abstraction, from a plurality of directions, on a human body model having three-dimensional information and indicating a first pose associated with a first label, generating a plurality of pieces of first abstracted information each having two-dimensional information and respectively corresponding to the plurality of directions by performing the abstraction, and associating the first label with each of the plurality of pieces of first abstracted information, wherein
the plurality of pieces of first abstracted information and second abstracted information having two-dimensional information obtained by abstracting a second pose corresponding to the first pose in one domain are used for associating the first label with the second pose in the one domain.

12. An information processing program causing a processor to implement
an abstraction processing step of performing abstraction, from a plurality of directions, on a first pose having three-dimensional information and associated with a first label, generating a plurality of pieces of first abstracted information each having two-dimensional information and respectively corresponding to the plurality of directions by performing the abstraction, and associating the first label with each of the plurality of pieces of first abstracted information, wherein
the plurality of pieces of first abstracted information and second abstracted information having two-dimensional information obtained by abstracting a second pose corresponding to the first pose in one domain are used for associating the first label with the second pose in the one domain.

13. An information processing apparatus comprising:
an abstraction processing unit configured to perform abstraction on a person included in an input video to generate abstracted information having two-dimensional information; and
an inference unit configured to perform inference on a label corresponding to the abstracted information by using a machine learning model, wherein
the inference unit
performs the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.

14. The information processing apparatus according to claim 13, wherein
the abstraction processing unit
performs the abstraction by estimating skeleton information of the person.

15. The information processing apparatus according to claim 13, wherein
the inference unit
searches, from the plurality of pieces of first abstracted information, the first pose similar to a pose estimated from the skeleton information of the person, and acquires the label associated with the first pose searched as a result of the inference.

16. The information processing apparatus according to claim 13, further comprising
a communication unit configured to transmit the input video and the label.

17. An information processing method executed by a processor, the information processing method comprising:
an abstraction processing step of performing abstraction on a person included in an input video to generate abstracted information having two-dimensional information; and
an inference step of performing inference on a label corresponding to the abstracted information by using a machine learning model, wherein
the inference step
executes the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.

18. An information processing program causing a processor to implement:
an abstraction processing step of performing abstraction on a person included in an input video to generate abstracted information having two-dimensional information; and
an inference step of performing inference on a label corresponding to the abstracted information by using a machine learning model, wherein
the inference step
executes the inference by the machine learning model trained using a plurality of pieces of first abstracted information generated by performing abstraction, from a plurality of directions, on a human body model having three-dimensional information and indicating a first pose associated with the label, the plurality of pieces of first abstracted information each having two-dimensional information and respectively corresponding to the plurality of directions, and second abstracted information having two-dimensional information obtained by abstracting a second pose corresponding to the first pose in one domain.
